(19) United States
(12) Patent Application Publication
(10) Pub. No.: US 2025/0326952 A1
(43) Pub. Date: Oct. 23, 2025

(54) Pipeline Repair Epoxy Composites, Methods, and Applications

(71) Applicant: Pipeline Coatings Systems LLC, Cuddy, PA (US)

(72) Inventors: John G. Gillen, Pittsburgh, PA (US); Don Peter Hart, Jr., Pittsburgh, PA (US)

(21) Appl. No.: 18/701,484

(22) PCT Filed: Oct. 14, 2022
(86) PCT No.: PCT/US2022/046705

§ 371 Date: Apr. 15, 2024

Related U.S. Application Data
(60) Provisional application No. 63/255,979, filed on Oct. 15, 2021.

(51) Int. Cl. C09J 7/10; C09J 5/02; C09J 5/06; C09J 7/35; C09J 11/04; C09J 11/08; F16L 55/168

(52) U.S. Cl. CPC C09J 7/10; C09J 5/02; C09J 5/06; C09J 7/35; C09J 11/04; C09J 11/08; F16L 55/1683; C09J 2301/304; C09J 2301/408

(57) ABSTRACT

A prepreg epoxy-based carbon and/or glass and/or Kevlar fiber composite for application to a metal substrate, such as an oil and gas pipeline pipe and water pipe and pipeline repair, includes about 5-50% liquid or solid epoxy; about 5-50% epoxy novolac resin; about 5-10% curing agent; about 5-10% accelerator; about 3-15% rubber modified epoxy resin for toughening; and about 30-70% glass and/or carbon fiber fabric. Also included is a method of making the epoxy prepreg composite and the methods of wrapping the epoxy prepreg composite around the pipeline area to be repaired and using a flexible, electric heat blanket or heat belt to cure the epoxy prepreg composite in the field.

### CROSS REFERENCE TO RELATED APPLICATIONS

This application is the United States national phase of International Application No. PCT/US22/46705 filed Oct. 14, 2022, and claims the benefit of U.S. Provisional Application No. 63/255,979, filed Oct. 15, 2021, the entire disclosures of which are incorporated herein by reference in their entireties.

### FIELD

This invention relates to epoxy composites, methods of making same, methods of using same for applications in coating and repairing pipeline pipe.

### BACKGROUND OF THE INVENTION

Due to the inherent risk of transporting oil, natural gas and other natural gas and/or liquids, the metal pipes used to transport these products require additional corrosion protection to ensure their safety. Pipeline pipe for oil and gas may be about 4 to 42 inches in diameter, and thus, circumference may be about 12 to about 130 inches. Pipe for water and other applications may be up to about 80 inches in diameter.

Sometimes pipes, both for oil and gas and also for water pipes, develop corrosion that corrodes a significant portion of the pipes thickness—i.e., from about 20% to 75%. Additionally, sometimes during the course of its use, a pipe can develop a dent on its side. This corrosion or dent can affect the amount of internal pressure a pipe can safely handle.

There are different methods of repairing these anomalies—removing the pipe and replacing it, welding a piece of steel over top, winding with metal spring and securing it, and also over the last 15-20 years the use of composite repair. The composite repair uses fiberglass (and/or Kevlar fiber and/or carbon fiber) cured with either two-part liquid epoxy or polyurethane. With liquid epoxy it is necessary to mix the liquid resin (A side) with the liquid curing agent (B side), and then spreading the mixture onto fiberglass sheet or roving. The liquid epoxy will cure shortly after its mixture—24 hours or less. The liquid epoxy has to be mixed and coated onto the fiberglass at the jobsite.

With polyurethane, one of the methods that is used is moisture cured urethane. The moisture curable urethane will be spread over the fiberglass at a plant and then placed into a bag that resists moisture. At the jobsite, the moisture curable urethane fiberglass will be removed from the bag and then wrapped around the pipe. The moisture in the air can cure the urethane, although usually in practice as they wrap this composite, water is sprayed on each layer and they wrap it with plastic film, perforate the plastic film and then pour water onto it. The water makes its cure faster, but it also makes the urethane foam from the reaction. The plastic film prevents it's from swelling too much. This moisture cured urethane is the same technology currently used for cast on broken bones.

U.S. Pat. Nos. 7,500,494B2, 7,673,654B2, and CN100451428C generally describe the two part-liquid epoxy that is used to saturate the fiberglass and then cured to form the composite repair at the jobsite.

In the United States, oil and gas pipelines (on land) generally utilize a dual corrosion protection system: a specialized epoxy coating provides the main protection, while as an additional measure the pipes have electrical cathodic protection (“CP”). A simple explanation of CP is that metal can only rust when it gives off electrons. If electricity is run through the metal it is unable to rust. A CP system is installed on the oil and gas pipelines to prevent rust.

The specialized epoxy coating is commonly known as fusion bonded epoxy (“FBE”). FBE is typically applied to a pipeline as a powder composed primarily of solid epoxy resin and a curing package, such as dicyandiamide with an accelerator. The dicyandiamide together with the accelerator is known as the ‘curing agent’ or ‘curing agent package.’ This curing agent package needs a temperature above about 250° F. to melt and start to cure.

To manufacture FBE powder, the solid epoxy resin is heated to its melting point (approximately 220° F.), mixed with the curing agents then quickly chilled to stop any reaction between the epoxy and the curing agents. After the mixture is solidified, it is then ground into a powder. The powder is typically about 100μ to about 1000μ in size. See e.g., U.S. Pat. No. 3,904,346 to Shaw et al. The solid epoxy resin component of the FBE powder has a high molecular weight and is very friable.

At a pipe coating facility, the metal pipe is typically treated by sand blasting, washing and cleaning and then heating to about 450° F. Then, the FBE powder is dry sprayed onto the hot pipe where it quickly melts and flows into a continuous coating, the curing agent can react with the epoxy resin to fully coat the pipe. Pipeline pipe is typically made in 40 foot lengths. At the pipe coating facility, typically the whole length of the pipe is coated except for the last 3 inches of either end of the 40 foot long pipe section. The ends of the pipe are left uncoated so that when the pipe sections are welded together in the field, a clean weld can be achieved.

When an oil and gas pipeline is constructed, the factory applied FBE coated pipe is transported out to the field and then all the sections of pipe are welded together. Each weld may be inspected by X-ray or other means to ensure structural integrity. The weld area (and uncoated adjacent area) is then cleaned and sand blasted to prepare it for coating in the field. This coating is called a field joint coating. There are two main types of field joint coating: the FBE powder coating described above or a two-part liquid epoxy coating. The two parts of the liquid coating are “A side” which is a liquid epoxy resin and the “B side” which is the liquid amine based curing agent. The liquid two-part epoxy is mixed shortly before application. Both methods of field joint coating have their limitations.

The coating of the weld area with FBE powder is difficult and capital intensive because of the high curing temperature. The pipe has to be preheated to about 450° F. with an induction coil and then powder spray coated with specialized equipment. An example of coating the pipeline weld area and using induction heating may be seen here: https://youtu.be/a4jSz-YaVMo. However, there is the belief that the FBE powder provides better corrosion protection than the two-part liquid epoxy. This may be due to the uniformity of coating and material used in the coating facility and in the field.

The coating of the weld area with the two-part liquid epoxy can be done either by hand brush application or by special liquid spray equipment. When applied by hand brush, the epoxy coating is usually supplied in one-liter kits, consisting of two different pails, one with the A side resin and another of the B side curing agent. The two sides are thoroughly mixed together and then applied to the weld area. The kits are supplied in one-liter quantities as the material immediately begins to react and is unusable after 10-20 minutes. With the one-liter kits, there may be a lot of excess material wasted depending on the circumference of the pipe. Additionally, the time to mix and apply the coating is manpower intensive. When applied by special liquid spray equipment, the two parts are kept separate from each other, and are only mixed together at the last second at the spray head nozzle. Spray application is capital intensive and requires a number of workers to manage the equipment, however it has less wasted coating material but there is still some material wasted due to various reasons.

Current technology exists to manufacture uncured or partially cured “B-staged” epoxy film that is flexible and formable. This epoxy film technology is used as an adhesive in the computer and semi-conductor industry and also in the automotive manufacturing industry. Additionally, the composite industry utilizes epoxy in the manufacture of “prepreg” fiberglass and carbon fiber sheets. For example, Chinese Applications CN102927407A, CN101205999A, and CN108997712A describe the use and manufacture of “prepreg” fiberglass and carbon fiber sheets for pipeline repair.

U.S. Pat. No. 5,589,019 to Van Beersel et al. describes a method for applying a polymeric tape material composed of either polyester, polypropylene or polyethylene to a pipeline pipe field joint using a device that comprises a frame and rollers. Other references generally describe two-part liquid coatings for pipeline and field joint applications, FBE powders, FBE alternatives, and methods of applying the same, including US20070241558A1 to Nestegard et al., WO2009143602A1 to Cunningham et al., US20070034316A1 to Perez et al., US20070277733A1 to Wood et al., U.S. Pat. No. 5,178,902 to Wong et al., U.S. Pat. No. 8,522,827 to Lazzara et al., and U.S. Pat. No. 5,709,948 to Perez et al. U.S. Provisional Application Ser. No. 63/163,977 filed on Mar. 22, 2021, and which has been published under International PCT Application Publication No. WO 2022/204124, entitled “Fusion Bonded Epoxy Film and Applications for Same,” with a common assignee, is herein incorporated by reference in its entirety.

U.S. Provisional Application Ser. No. 63/163,977 filed on Mar. 22, 2021, published under International PCT Application Publication No. WO 2022/204124, entitled “Fusion Bonded Epoxy Film and Applications for Same,” with a common assignee, is herein incorporated by reference in its entirety (“FBE Film Provisional Application”). In the FBE Film described in WO 2022/204124, a partially cured FBE film was described for application to any metal substrate, such as a pipeline pipe and pipeline pipe weld areas. As described in the FBE Film described in WO 2022/204124, “uncured” or “partially cured,” meant about 1-20% cured, flexible FBE film was manufactured for later application to a substrate. The FBE film could be made and cut into particular lengths and widths for later application onto a substrate and differs from a coating that is applied and cured directly onto the substrate to form a coating in real time in the field. The FBE Film described in WO 2022/204124 was primarily directed to field joint coatings and was lacking the fiberglass and/or Kevlar fiber and/or carbon fiber fabric component that is necessary in repairing and/or rehabilitating a pipeline.

There is a need to create a one component epoxy that will be coated onto fiberglass and/or Kevlar fiber and/or carbon fiber fabric at a plant and wound into coil to create an epoxy prepreg composite material. At the jobsite, the material will be wrapped around the pipe and then, using a heat source, cured in the field.

### SUMMARY OF THE INVENTION

One embodiment of the invention is a partially-cured epoxy saturated glass and/or Kevlar and/or carbon fiber fabric for use on pipeline pipe, including for use in repairs and/and rehabilitating the pipeline, comprising: about 5-50% liquid or solid epoxy, about 5-50% epoxy novolac resin, about 5-10% curing agent, about 5-10% accelerator, about 3-15% rubber modified epoxy resin for toughening and improved peel adhesion, and about 30-70% glass and/or Kevlar and/or carbon fiber fabric.

Another embodiment of the invention is a method of making a partially-cured epoxy saturated glass and/or Kevlar and/or carbon fiber fabric for use on pipeline pipe, said method comprising: (1) loading fiber glass fabric and/or Kevlar and/or carbon fiber fabric onto a machine and pulling the fabric through rollers; (2) coating the fabric with an epoxy mix, which is in liquid form, either through the use of liquid epoxy resin or solid epoxy that has been heated or diluted with solvent to make it liquid; (3) saturating the fabric, creating a coated fabric; (4) pulling the coated fabric through the rollers to squeeze the epoxy mix thoroughly into the fabric and to remove any excess resin and drive off the solvent, so that there is no dripping of the epoxy resin; and (5) controlling the temperature to create a partially-cured epoxy saturated glass and/or Kevlar and/or carbon fiber fabric for use on pipeline pipe. The method may further comprise cutting the partially-cured epoxy saturated glass and/or carbon fiber fabric into a width of about 2 to 12 inches.

Another embodiment of the invention is a method of repairing a piece of metal pipeline pipe, comprising: (1) exposing a piece of pipeline pipe to be repaired; (2) cleaning damaged area of pipeline pipe to be repaired of debris and rust, including using a sand blaster or mechanical abrader to clean the area around the pipe that will be repaired; (3) wiping the area around the pipe that will be repaired with acetone or other solvent cleaner; (4) applying epoxy filler to the damaged area; (5) wrapping area of the pipe to be repaired with a fusion bonded epoxy film or coating a two-part liquid epoxy around the area of the pipe to be repaired to ensure sufficient adhesion to the steel pipe; (6) wrapping a glass and/or Kevlar and/or carbon fiber fabric pre-saturated with partially-cured epoxy around the repair pipe more than one time; (7) optionally wrapping a peel ply comprising a nylon or polyester fabric around the pre-saturated glass and/or Kevlar and/or carbon fiber fabric; (8) optionally wrapping a compression film around the pre-saturated glass and/or Kevlar and/or carbon fiber fabric to consolidate the matrix; (9) wrapping a flexible heat belt or blanket around the peel ply; and (10) temperature controlling the heat belt or blanket for a cure period of time.

The methods of repairing the pipeline pipe may use a glass and/or Kevlar and/or carbon fiber fabric pre-saturated with epoxy having a formula of: about 5-50% liquid or solid epoxy; about 5-50% epoxy novolac resin; about 5-10% curing agent; about 5-10% accelerator; about 3-15% rubber modified epoxy resin for toughening; and about 30-70% glass and/or Kevlar and/or carbon fiber fabric. The methods of repairing may further comprise the step of wrapping a plastic film release liner over the peel ply before wrapping the flexible heat belt or blanket. The cure time may be about 30 minutes to about 2 hours. The cure temperature may be about 150° F. to about 450° F.

Another embodiment of the invention is a method of repairing a piece of metal pipeline pipe, comprising: (1) exposing a piece of pipeline pipe to be repaired; (2) cleaning damaged area of pipeline pipe to be repaired of debris and rust, including using a sand blaster or mechanical abrader to clean the area around the pipe that will be repaired; (3) wiping the area around the pipe that will be repaired with acetone or other solvent cleaner; (4) applying epoxy filler to the damaged area; (5) wrapping area of the pipe to be repaired with a fusion bonded epoxy film or coating a two-part liquid epoxy around the area of the pipe to be repaired; (6) wrapping a glass and/or Kevlar fiber fabric pre-saturated with partially-cured epoxy around the repair pipe more than one time; (7) wrapping a carbon fiber fabric pre-saturated with partially-cured epoxy around the repair pipe more than one time; (8) wrapping a peel ply comprising a nylon fabric around the pre-saturated glass and/or Kevlar fiber fabric and pre-saturated carbon fiber fabric; (9) wrapping a flexible heat belt or blanket around the peel ply; and (10) temperature controlling the heat belt or blanket for a cure period of time.

Another embodiment of the invention is a method of using a flexible heat belt to cure an epoxy composite material onto a pipeline surface using a three-part temperature-controlled heat schedule.

The present invention is also directed to the following aspects
Aspect 1: A partially-cured epoxy saturated glass, Kevlar, and/or carbon fiber fabric for use on pipeline or water pipe, comprising: about 5-50% liquid or solid epoxy; about 5-50% epoxy novolac resin; about 5-10% curing agent; about 5-10% accelerator; about 3-15% rubber modified epoxy resin for toughening; and about 30-70% glass and/or carbon fiber fabric.
Aspect 2: The partially-cured epoxy saturated glass, Kevlar, and/or carbon fiber fabric of aspect 1, wherein the partially-cured epoxy saturated glass, Kevlar, and/or carbon fiber fabric is a partially-cured epoxy saturated glass.
Aspect 3: The partially-cured epoxy saturated glass, Kevlar, and/or carbon fiber fabric of aspect 1, wherein the partially-cured epoxy saturated glass, Kevlar, and/or carbon fiber fabric is a partially-cured epoxy saturated Kevlar.
Aspect 4: The partially-cured epoxy saturated glass, Kevlar, and/or carbon fiber fabric of aspect 1, wherein the partially-cured epoxy saturated glass, Kevlar, and/or carbon fiber fabric is a partially-cured epoxy saturated carbon fiber fabric.
Aspect 5: The partially-cured epoxy saturated glass, Kevlar, and/or carbon fiber fabric of any one of aspect 1-4, wherein the liquid or solid epoxy is selected from the group consisting of 1,2-cyclic ethers, 1,3-cyclic ethers, 1,4-cyclic ethers, and combinations thereof.
Aspect 6: The partially-cured epoxy saturated glass, Kevlar, and/or carbon fiber fabric of any one of aspects 1-5, wherein the liquid or solid epoxy comprises more than one epoxy groups.
Aspect 7: A pipeline or water pipe at least partially coated with a partially-cured epoxy saturated glass, Kevlar, and/or carbon fiber fabric according to any one of aspects 1-6.
Aspect 8: A method of making a partially-cured epoxy saturated glass and/or Kevlar and/or carbon fiber fabric for use on pipeline pipe, said method comprising: loading fiber glass fabric and/or carbon fiber fabric onto a machine and pulling the fabric through rollers; coating the fabric with an epoxy mix, which is in liquid form, either through use of a liquid epoxy resin or a solid epoxy that has been heated or diluted with solvent to make the solid epoxy a liquid; saturating the fabric to create a coated fabric; pulling the coated fabric through the rollers to squeeze the epoxy mix into the fabric and remove any excess resin and at least a portion or all of the solvent, so that there is no dripping of the epoxy resin; and controlling the temperature to create a partially-cured epoxy saturated glass and/or Kevlar and/or carbon fiber fabric for use on pipeline pipe.
Aspect 9: The method of aspect 8, further comprising cutting the partially-cured epoxy saturated glass and/or carbon fiber fabric into a widths of about 2 to 12 inches.
Aspect 10: A method of repairing a piece of metal pipeline pipe, comprising: exposing a piece of pipeline pipe to be repaired; cleaning damaged area of pipeline pipe to be repaired of debris and rust; wiping the area around the pipe that will be repaired with a solvent cleaner; applying epoxy filler to the damaged area; wrapping an area of the pipe to be repaired with a fusion bonded epoxy film or coating a two-part liquid epoxy around the area of the pipe to be repaired to ensure sufficient adhesion to the steel pipe; wrapping a glass and/or Kevlar and/or carbon fiber fabric pre-saturated with partially-cured epoxy around the repair pipe more than one time; wrapping a peel ply comprising a nylon or polyester fabric around the pre-saturated glass and/or Kevlar and/or carbon fiber fabric; wrapping a flexible heat belt or blanket around the peel ply; and temperature controlling the heat belt or blanket for a cure period of time.
Aspect 11: The method of aspect 10, wherein the glass and/or Kevlar and/or carbon fiber fabric pre-saturated with epoxy comprises: about 5-50% liquid or solid epoxy; about 5-50% epoxy novolac resin: about 5-10% curing agent; about 5-10% accelerator; about 3-15% rubber modified epoxy resin for toughening; and about 30-70% glass and/or Kevlar and/or carbon fiber fabric.
Aspect 12: The method of aspect 10 or 11, further comprising the step of wrapping a plastic film release liner over the peel ply before wrapping the flexible heat belt or blanket.
Aspect 13: The method of any one of aspect 10-12, wherein the cure time is about 30 minutes to about 2 hours.
Aspect 14: The method of any one of aspects 10-13, wherein the cure temperature is about 150° F. to about 450° F.
Aspect 15: A method of wrapping an epoxy composite material around a piece of metal pipeline pipe, comprising: exposing a piece of pipeline pipe to be repaired; cleaning damaged area of pipeline pipe to be repaired of debris and rust; wrapping a glass fiber and/or Kevlar and/or carbon fiber fabric pre-saturated composite with a partially-cured epoxy around the pipeline pipe to be repaired more than one time; wrapping a flexible heat belt around the composite more than one time, wherein the flexible heat belt has a width of about 4 to about 8 inches; and temperature controlling the heat belt for a cure period of time.
Aspect 16: The method of aspect 15, wherein the temperature controlling step includes a three-part temperature ramping up.
Aspect 17: The method of aspect 16, wherein the three-part temperature ramp up comprises: increasing a temperature on the heat belt to about 200° F.-220° F. at an increase rate of about 5-10° F. per minute and holding at about 200° F.-220° F. for about 10 minutes; next, increasing the temperature on the heat belt to about 280° F. to 300° F. at an increase rate of about 5-10° F. per minute and holding at about 280° F. to 300° F. for about 15 minutes; and, next, increasing the temperature on the heat belt to about 330° F.-350° F. at an increase rate of about 5-10° F. per minute and holding at about 330° F.-350° F. for about 15 minutes.
Aspect 18: The method of aspect 17, wherein there is a final ramp down step comprising: lowering the temperature of the heat belt to about 120° F.-140° F. at a decrease rate of about 5-10° F. per minute and holding there for about 10 minutes before removing the heat belt from the pipeline.

### BRIEF DESCRIPTION OF THE DRAWINGS

FIG. 1 is a photograph of a heat belt that is 4-inch wide to be used in the methods according to one or more embodiments of the present invention.

FIG. 2 illustrates composites made by the manufacturing process for both hot melt and solvent diluted prepreg composites as described in Section 3.2 of Hengsfeld, et al., “Composite Technology: Prepregs and Monolithic Part Fabrication Technologies,” Hanser, Munich, 2015.

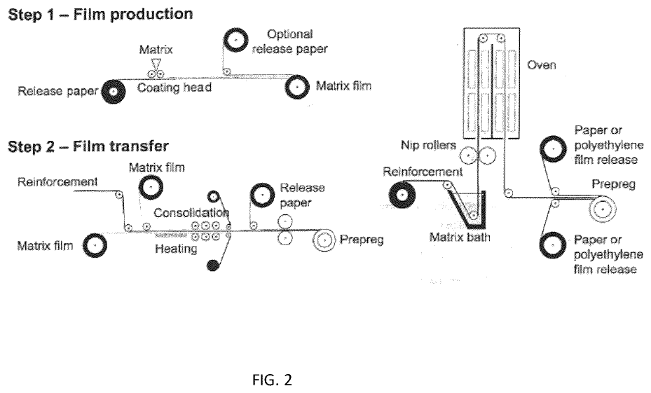

### DETAILED DESCRIPTION OF THE INVENTION

In the FBE Film described in International PCT Application Publication No. WO 2022/204124, an FBE film was described for application to any metal substrate, such as a pipeline pipe and pipeline pipe weld areas. As described in WO 2022/204124, “uncured” or “partially cured,” meant about 1-20% cured, flexible FBE film was manufactured for later application to a substrate. The FBE film could be made and cut into particular lengths and widths for later application onto a substrate and differs from a coating that is applied and cured directly onto the substrate to form a coating in real time in the field.

A partially-cured, flexible fusion bonded (“FBE”) epoxy film for application to a substrate as described in WO 2022/204124 described: about 40 to 80% by weight epoxy resin, about 5 to 25% by weight resin modifiers and tougheners, about 3 to 10% by weight curing agent, such as dicyandiamide, amidoamine or imidazole, about 1 to 4% by weight accelerator, about 20 to 50% by weight filler, and about 0-1% by weight additives. The FBE film could be made with a thickness of about 0.005 to about 0.05 inches and a curing temperature of about 275° F. to about 450° F.

As used herein, in the present invention, the term “pre-preg” or “prepreg,” means pre-impregnated, or pre-saturated, such that the carbon and/or Kevlar and/or glass fiber fabric is pre-impregnated with melted, solvent diluted or liquid epoxy in a shop setting and then allowed to cool, stored and transported to the field before final curing onto the pipeline pipe in the field. The epoxy prepreg composite according to one embodiment of the invention is carbon and/or glass fiber fabric saturated with epoxy, which is transportable to the field for curing onto a pipeline.

The present epoxy prepreg composite may be used on metal pipelines to make repairs and/or rehabilitations. Types of metal pipeline repairs and/or rehabilitations, include, but are not limited to:
1. External or internal corrosion: effect, metal loss and reduction in pipe wall thickness including but not limited to rust, chemical exposure, outside electrochemical attack, improper application of original protective coating on girth-welds or general pipe, and corrosive soil.
2. Mechanical damage: from pipe installation, construction in the area, other utility work, and change of use in the area. Damage to include pipe dents, scrapes, and gouges.
3. Improved use: Increase in pipe pressure, increase in flow rate of cargo transported by the pipe, and increase in the safety of the pipe due to the change of use of the topside real estate. (ie; farm land to school).

There are several benefits of epoxy prepreg composite repair of pipelines over other composite repair technologies. For example, in comparing the present invention to two-party liquid epoxy or “wet layup” applications, the prepreg composite offers, at least the following advantages:

Higher loading of fibers in prepreg (i.e. up to and above 60% fibers to resin) versus loadings of fibers ranging from 30-50% in wet layup.

Less waste of excess resin due to higher fiber loading.

No need to prepare the wet layup by saturating the fibers with the epoxy resins. The use of epoxy prepreg allows for quicker application of the repair.

Less mess, don't have brushes and rollers dripping resin. The use of epoxy prepreg eliminates empty cans of resin that could be hazardous.

The prepreg can be applied in continuous strands of material (up to 20 feet long). Versus wet layup being saturated in smaller sections, typically 18-36 inches long. Better strength with the continuous strands as opposed to requiring the resin to provide continuous strength.

Elimination of the risk of incorrect measurement of the curing agent.

Prepregs allow the ability to use higher strength and higher performance epoxy resins and resin modifiers (i.e. epoxy novolacs and epoxy functional rubber tougheners). Generally, epoxy resins that have improved chemical resistances and higher temperature resistances (higher glass transition temperatures—Tg) have a higher number of crosslinking sites. These higher crosslinking sites raise the viscosity of the resin. For example, one resin that may be used is Epon 438 from Olin, which is an epoxy novolac. Epon 438 has a viscosity of approximately 200,000 centipoise at 77° F. and an average crosslink density of 3.5 sites per molecule. If this were to be incorporated into a wet layup system, the resulting viscosity would make the mixed resin difficult to spread and saturate the fibers in the field. However, with the plant manufacture of epoxy prepregs utilizing either hot melt or solvent dilution, both of which would lower the viscosity of the resin mix, the fibers would be wetted out and fully saturated. Further, an epoxy functional rubber toughener that may be used is HyPox RA 840 from Huntsman, it has a viscosity of 190,000 centipoise at 77° F. HyPox RA 840 is a Bis-A epoxy resin adducted with a CTBN rubber, used as a reactive toughener to increase toughness, impact resistance, and peel adhesion.

Prepregs allow the compaction of the resin/fiber matrix during manufacturing by rolls in the plant line. This compaction eliminates any air pockets, thus improving the overall strength of the system.

Prepregs allow uniformity and repeatability of manufacture. There will be less variability of the applicator of the wet layup. With prepregs the resin/fiber matrix will be uniform with elimination of resin rich or resin starved spots common with hand wet layup.

Prepregs need less time for complete curing. After the heat cycle is finished, it is ready for service. With wet layup it can take up to 48 hours to cure.

Prepregs allow faster application time, saving applicators costs.

With wet layup, a two-part epoxy primer is required before application of the fiber/resin matrix, some primers require two hours or more to cure depending on the outside temperature. The epoxy prepreg can use an FBE Film primer, that can be cured at the same time as the composite repair.

There are several benefits of epoxy prepreg composite repair of pipelines over other composite repair technologies. For example, in comparing the present invention to moisture-cured or heat-cured urethane technology, the epoxy prepreg composite offers, at least the following advantages:

Epoxy generally has better adhesion to steel than urethane. The urethane system will need to use a two-part epoxy primer for better adhesion, which can take 2 hour or more to cure before applying the urethane prepreg.

Epoxy has better chemical resistance than urethane systems. This could be of issue in applications where the repair would be exposed to various chemicals, gasolines etc, such as in a chemical plant.

Epoxy has better high heat resistance than urethane systems. Sometimes oil or gas flows through pipes at elevated temperatures. Additionally, after a pipeline pumping station, the material flowing through the pipe is heated, sometimes in excess of 200° F.

Urethane can become damaged after prolong exposure to elevated temperatures, the cured urethane becomes friable. Epoxies, and in particular epoxies formulated with epoxy novolacs, have higher glass transition points allowing higher working temperatures. The higher the amount of the epoxy novolac the higher the glass transition point.

Epoxies have higher overall mechanical strengths such as hardness, tensile strength and hoop strength. The higher hardness would be of particular benefit with ARO prepreg wraps.

One embodiment of the invention is a partially-cured epoxy saturated glass and/or Kevlar and/or carbon fiber fabric for use on pipeline pipe, comprising: about 5-50% liquid or solid epoxy, about 5-50% epoxy novolac resin, about 5-10% curing agent, about 5-10% accelerator, about 3-15% rubber modified epoxy resin for toughening, and about 30-70% glass and/or Kevlar and/or carbon fiber fabric.

Kevlar® Para-Aramid (referred to as “Kevlar” herein) is an aromatic polyamide that is characterized by long rigid crystalline polymer chains and is commercially available from DuPont. Any hybrid of fiber materials may be used. Traditionally, fiberglass has been used in composite repairs. Kevlar fiber, which is more expensive, may be woven into fiberglass base to increase the strength. Methods are known to make woven glass and/or carbon composite fabric materials.

The manufacture of prepregs with glass and/or Kevlar and/or carbon fiber fabric is generally known. For example, as described in the textbook by Hengsfeld, et al., “Composite Technology: Prepregs and Monolithic Part Fabrication Technologies,” Hanser, Munich, 2015, herein incorporated by reference in its entirety, the composites made by the manufacturing process for both “hot melt” and “solvent diluted” prepreg composites as described in Section 3.2 may be used to generally prepare the fiber component(s) of the prepreg. If a solvent diluted prepreg is manufactured, the VOC content of the resulting composite should be less than 3%.

One embodiment of the invention is a one component epoxy prepreg composite. To manufacture this epoxy prepreg composite, fiber glass fabric or Kevlar or carbon fiber fabric is loaded onto a machine and pulled through rollers. The machinery described in in the textbook by Hengsfeld, et al., “Composite Technology: Prepregs and Monolithic Part Fabrication Technologies” may be used. An epoxy mix, which is in liquid form—either through the use of liquid epoxy resin or solid epoxy that has been heated or diluted with solvent to make it liquid—is coated onto the fabric, saturating the fabric. This coated fabric is then pulled through rollers to squeeze the epoxy mix thoroughly into the fabric and to remove any excess resin. With epoxy prepreg it is possible to maximize the amount of fabric to epoxy, thus increasing its strength. This fabric will then either be partially cured—for liquid epoxy resin—or chilled or solvent removed—for solid epoxy resin that has been pre-heated—to create a prepreg that can be handled easily with no dripping of the epoxy resin. The epoxy prepreg composite is allowed to cool and then stored for later use in the field.

The epoxy prepreg composite may be manufactured to be between about 2 to 12 inches wide. The epoxy prepreg composite may be stored as rolls of material—with a release liner between each layer of material to prevent further curing or sticking. The thickness of the stored epoxy prepreg composite may be anywhere from 0.03 to 0.50 inches thick.

The release layer may be thought of as a backing surface, such as a thin plastic film with a silicone release layer, and thus allowing the epoxy prepreg composite to be spun into a roll or spool of material, with an optional center tube. Widths of the rolls can be adjusted by application. For example, in the field, a width of about 4 or 12 inches is contemplated to accommodate a typical repair, depending on the diameter of the pipe. The length of the epoxy prepreg composite is at least the circumference of the pipeline to be wrapped, and, of course, it may be longer, as some repairs contemplate wrapping the composite around more than 1 time. The rolls could be as long as 50 feet. The thin plastic film with a silicone release layer may be about 0.003 to about 0.015 inches thick.

Another embodiment of the invention is a method of making a partially-cured epoxy saturated glass and/or Kevlar and/or carbon fiber fabric for use on pipeline pipe, said method comprising: (1) loading fiber glass and/or Kevlar fabric and/or carbon fiber fabric onto a machine and pulling the fabric through rollers; (2) coating the fabric with an epoxy mix, which is in liquid form, either through the use of liquid epoxy resin or solid epoxy that has been heated or diluted with solvent to make it liquid; (3) saturating the fabric, creating a coated fabric; (4) pulling the coated fabric through the rollers to squeeze the epoxy mix thoroughly into the fabric and to remove any excess resin and solvent, so that there is no dripping of the epoxy resin; and (5) controlling the temperature to create a partially-cured epoxy saturated glass and/or Kevlar and/or carbon fiber fabric for use on pipeline pipe. The method may further comprise cutting the partially-cured epoxy saturated glass and/or carbon fiber fabric into a width of about 2 to 12 inches.

Another embodiment of the invention is a method of repairing a piece of metal pipeline pipe, comprising: (1) exposing a piece of pipeline pipe to be repaired; (2) cleaning damaged area of pipeline pipe to be repaired of debris and rust, including using a sand blaster or mechanical abrader to clean the area around the pipe that will be repaired; (3) wiping the area around the pipe that will be repaired with acetone or other solvent cleaner; (4) applying epoxy filler to the damaged area; (5) wrapping area of the pipe to be repaired with a fusion bonded epoxy film or coating a two-part liquid epoxy around the area of the pipe to be repaired to ensure sufficient adhesion to the steel pipe; (6) wrapping a glass and/or Kevlar and/or carbon fiber fabric pre-saturated with partially-cured epoxy around the repair pipe more than one time; (7) optionally wrapping a peel ply comprising a nylon or polyester fabric around the pre-saturated glass and/or Kevlar and/or carbon fiber fabric; (8) wrapping a flexible heat belt or blanket around the peel ply; and (9) temperature controlling the heat belt or blanket for a cure period of time.

The methods of repairing the pipeline pipe may use a glass and/or Kevlar and/or carbon fiber fabric pre-saturated with epoxy having a formula of: about 5-50% liquid epoxy; about 5-50% epoxy novolac resin; about 5-10% curing agent; about 5-10% accelerator; about 3-15% rubber modified epoxy resin for toughening; and about 30-70% glass and/or carbon fiber fabric. The methods of repairing may further comprise the step of wrapping a plastic film release liner over the peel ply before wrapping the flexible heat belt or blanket. The cure time may be about 30 minutes to about 2 hours. The cure temperature may be about 150° F. to about 450° F.

Another embodiment of the invention is a method of repairing a piece of metal pipeline pipe, comprising: (1) exposing a piece of pipeline pipe to be repaired; (2) cleaning damaged area of pipeline pipe to be repaired of debris and rust, including using a sand blaster or mechanical abrader to clean the area around the pipe that will be repaired; (3) wiping the area around the pipe that will be repaired with acetone or other solvent cleaner; (4) applying epoxy filler to the damaged area; (5) wrapping area of the pipe to be repaired with a fusion bonded epoxy film or coating a two-part liquid epoxy around the area of the pipe to be repaired; (6) wrapping a glass fiber fabric pre-saturated with partially-cured epoxy around the repair pipe more than one time; (7) wrapping a carbon fiber fabric pre-saturated with partially-cured epoxy around the repair pipe more than one time; (8) wrapping a peel ply comprising a nylon fabric around the pre-saturated glass fiber fabric and pre-saturated carbon fiber fabric; (9) wrapping a flexible heat belt or blanket around the peel ply; and (10) temperature controlling the heat belt or blanket for a cure period of time.

A suitable curing package, such as a dicyandiamide (dicy) with an accelerator, may be used. To make the epoxy liquid, a solid epoxy resin may be heated to the melting point of the solid epoxy resin, such that some of the solid may be melted into a liquid form and allowed to flow or the solid epoxy may be diluted with a suitable solvent.

Epoxy resins preferably comprise compounds which contain one or more 1,2-, 1,3- and 1,4-cyclic ethers, which also may be known as 1,2-, 1,3- and 1,4-epoxides. The 1,2-cyclic ethers are preferred. Such compounds can be saturated or unsaturated, aliphatic, alicyclic, aromatic or heterocyclic, or can comprise combinations thereof. Compounds that contain more than one epoxy group (i.e., polyepoxides) are preferred.

A wide variety of commercial epoxy resins are available and are listed or described in, e.g., the Handbook of Epoxy Resins, by Lee and Neville, McGraw-Hill Book Co., New York (1967); Epoxy Resins, Chemistry and Technology, Second Edition, C. May, ed., Marcell Decker, Inc., New York (1988); and Epoxy Resin Technology, P. F. Bruins, ed., Interscience Publishers, New York, (1968). Any of the epoxy resins described therein may be useful in preparation of the epoxy prepreg composite.

Examples of suitable curing agents include thermally latent curing agents well known to those of ordinary skill in the art and, as will be apparent to one skilled in the art, are preferably selected taking into consideration the residence time and temperature profile in the compounding equipment. Examples of such suitable curing agents are imidazole, dicyandiamide, and cyanoguanidines (commonly known as DICY) available from CVC Specialty Chemicals Inc. under the trade name DDA or from Air Products and Chemicals Inc. of Allentown, PA, under the trade name Amicure CG 1200. Hydrazide compounds and hydrazines such as adipic acid dihydrazide (ADH) and isophtalic di-hidrazide (IDH) both available from A&C Catalysts Inc. of Linden, NJ, phenoloic hardeners such as the DEH line of products (DEH 85) from DOW Chemicals, anhydrides such as methyl hexahydrophtalic anhydride, nadic methyl anhydride and methyl tetrahydrophtalic anhydride, available from Dixie Chemical Company Inc. of Houston, TX may also be used as curing agents. Aliphatic and aromatic primary and secondary amines and their reaction products with epoxy resins, which are well known to act as curing agents for epoxy resins, may also be employed.

As an additional optional layer, an Abrasion Resistant Overcoat (“ARO”) prepreg wrap may be applied to pipeline welds and/or sections of pipelines, as has been described in the FBE Film in WO 2022/204124. AROs are typically applied over top of pipeline coatings on welds, and are used when pipes are pulled underground underneath an obstruction where a trench cannot be dug, i.e., a lake, highway, or river. Liquid two-part AROs require long cure times for their full properties to be realized. Heat curing dramatically shortens the cure time. Therefore, using the heat blanket and/or heat belt to cure the prepreg and/or FBE film and/or the ARO together in a single heating step of about 30-60 minutes is a time savings.

AROs are typically epoxy-based coatings and may include the novolac resin as described herein, but are generally harder and denser than FBE coatings. AROs are primarily used to prevent scratching and gouging, while FBE coatings act as a corrosive protective layer.

In certain applications, ARO prepreg wraps are preferred, such as a field joint coating in a directional drilling situation in particularly rocky environment. If an ARO prepreg wrap is to be used, the first step would be to apply the FBE film from the FBE Film described in WO 2022/204124 to coat the field joint. Next, one of three layers would be applied: (1) an epoxy prepreg composite according to the present invention, but also including a filler; (2) a standard fiberglass wrap; or (3) an FBE film with an ARO component. Once the two layers are applied to the pipe, the heat belt and/or heat blanket may be used to cure both layers together, resulting in a time savings.

The function of the filler in the above applications is to improve the physical properties of the coating, especially its impact resistance, corrosion resistance, and/or hardness. Suitable fillers that may be used include calcium carbonate, calcium sulfate, barium sulfate, clays, for example montmorillonite and bentonite, glass beads and bubbles, microbeads, ceramic beads, and mica, silica, feldspar and calcium metasilicate also known as wollastonite.

Other applications of the epoxy prepreg composite are contemplated, including using an epoxy prepreg composite to perform a repair of a section of corroded pipeline pipe, including digging up of the installed pipe and using the epoxy prepreg composite as a patch to perform a repair. The epoxy prepreg composite may be cut to suitable dimensions for use on repairs and in any thickness.

The epoxy prepreg composite may be wrapped around the oil and gas pipe and then cured by heat. In the field, wrapping epoxy prepreg composite may have to be somewhat manual and will account for the overlay of the epoxy prepreg composite in which to achieve the desired thickness of the repair. Curing time is a function of curing temperature as is known in the art. The epoxy prepreg composite may be cured at a range of temperatures (about 150° F. to about 450° F.) over a range of times (about 10 to about 120 minutes).

For field repair, those areas are optionally sand blasted to clean off rust and dirt. After treatment to the repair area, the area to be wrapped may be optionally preheated to about 100° F., but at a minimum heated to 5° F. above the dew point temperature. After the optional pre-heating, the epoxy prepreg composite will be wrapped around the damaged area of the pipe and cut to the proper length, which may correspond to the pipe's circumference or multiple times the pipe's circumference. Manual wrapping is contemplated, with an optional physical rolling of the epoxy prepreg composite down onto the area to be wrapped. The thin plastic film with a silicone release layer will be removed from the epoxy prepreg composite as it is applied over the repair area. Additionally, an optional shrinkable release layer or compression plastic wrap may be wrapped around the epoxy prepreg composite. The shrinkable release layer may be a polymeric tape film or other suitable material and is typically about 0.003 to about 0.015 inches thick. It would also be possible to use the peel ply to compress the prepreg and prevent damage to the heat blanket/belt. Alternatively, the thin plastic film with a silicone release layer may remain on only the outside portion of the epoxy prepreg composite before applying the heat source. The purpose of the shrinkable release layer or leaving the plastic backing layer in place is to prevent the epoxy coating melting onto the heat source. The shrinkable release layer, if used, should be wide enough to protect the epoxy from spreading too thin upon heating/curing. Additionally, any other methods may be used to prevent the epoxy from spreading too thin, including applying pressure to the repair area, such as by using bands or otherwise physically surrounding the repair area.

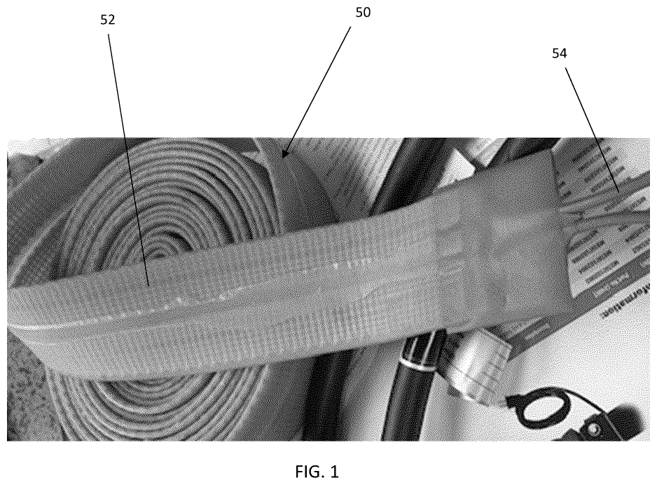

After the optional shrinkable release layer is applied, a flexible, electric heat blanket or heat belt may be wrapped around the shrinkable release layer/epoxy prepreg composite/repair area. The heat belt used may be the one seen in FIG. 1, which is one that is 4-inches wide. As shown in FIG. 1, a non-limiting embodiment of an electric heat belt 50 comprises a flexible body 52 with heating wires 54. Other dimensions are contemplated for the heat belt, including ones that are about 4-8 inches wide and up to about 50 feet long. The heat belt may be used in a variety of applications, on any number of cures in the field. Because it can be wrapped around any diameter of pipe, multiple times, in confined spaces, it is more versatile than a traditional “heat blanket” which is limited to specific dimensions and applications. The temperature control of the heat belt combined with its flexible and dimensions make it possible to use on curing repairs, field joint coatings, and in many other pipeline uses. Because the heat belt is flexible and easy to wrap around the pipe, the steps of digging up and exposing the pipe may be shortened in that workers can easily use it in small, confined spaces on pieces of exposed pipe.

A heat blanket/belt may be used to heat the epoxy prepreg composite and pipe to approximately 350° F. for about 30 to about 60 minutes for the complete cure. The shrinkable release layer may be used to keep the epoxy from ruining the heat blanket. Also, as the optional release layer shrinks, it will physically squeeze the epoxy prepreg composite onto the pipe, while stopping the epoxy from dripping off the pipe and achieving a better repair.

For field repairs, epoxy prepreg composite can be quickly applied manually, with the optional use of a manual or automatic roller to eliminate any air gaps. With the epoxy prepreg composite, very little epoxy material is wasted. Additionally advantageous is that the epoxy prepreg composite lower application costs than traditional two-part liquid epoxy repairs that are manually field-saturated.

The heat blanket and/or heat belt may be an electric, variable resistor, flexible heat blanket made of silicone rubber encapsulating heating wires, such as the one illustrated in FIG. 1. Silicone rubber heat blankets are commercially available for various other applications, including, for example, to heat 55-gallon metal drums. A heat blanket for use on pipeline heating may be customized to a preferred size and shape. Alternatively, the heat belt with the smaller widths can be wrapped around the pipe's circumference multiple times, like a ribbon winding around a tube. The silicone rubber heat blanket may be used to perform the pre-heating step and for performing the curing step. Alternatively, traditional propane torch heating may be used only to pre-heat the repair area to about 100° F., but at a minimum 5° F. above the dew point temperature to remove any moisture on the pipe. The metal pipes will also need to be heated to a minimum temperature of approximately 65° F. to allow the prepreg to remain flexible, otherwise the epoxy in the prepreg will become brittle and could crack.

Alternatively, the electric, flexible heat blanket may be a carbon nanotube heat blanket. Alternatively, the electric, flexible heat blanket may comprise polyimide and acrylic covering the circuitry of wires. Alternatively, the electric, flexible heat blanket may include aluminized cloth exteriors and fiberglass insulation. Any resistor-based flexible heat blanket may be used. Any suitable flexible, electric heat blanket or belt that may be powered by a portable generator may be used regardless of materials covering the circuitry of wires. Several flexible, electric heat blankets that are powered by a portable generator may be used in the field together, regardless of type, reducing the total time in performing and curing the repair. A heat belt with a narrow width would be preferred as it could be wound around pipes with different diameters and around pipes with different lengths of damage. A heat blanket would be limited to being used just to one diameter of pipe.

After optional pre-heating and the application of the epoxy prepreg composite and application of the optional shrinkable release layer, the flexible, electric heat blanket/belt is wrapped around the pipe repair area. The flexible, electric heat blanket/belt has a controller. Thus, the temperature can be controlled and adjusted during the cure. For example, if there is a pre-heating set, then the pipe will be about 100° F. Once the epoxy prepreg composite is applied and the heat blanket wrapped around the pipe, the temperature on the controller of the heat blanket may be set to about 150° F. to start the softening and flow of the epoxy. The temperature is held at 150° F. for about 5 to 10 minutes. Then, the temperature is increased to about 350° F. and held there for about 30 to 60 minutes. A temperature ramp down step may also be taken to allow for a slower and controlled cooling of the pipe. Next, the heat blanket is removed and the shrinkable release layer is removed.

As another example, if there is no pre-heating step, the temperature on the controller of the heat blanket may be set to about 150° F. to start the flow of the epoxy. The temperature is held at 150° F. about 5 to 10 minutes. Then, the temperature is increased to about 350° F. and held there for about 30 to 60 minutes.

The heat blanket/heat belt should be allowed to heat the epoxy composite prepreg to about 200° F.-220° F. at an increase rate of about 5-10° F. per minute. Once the temperature of about 200° F.-220° F. is reached on the top surface of the composite repair material, it should be held at this temperature for about 10 minutes to ensure the composite repair material reaches the same temperature throughout. At this temperature, the epoxy resin mixture's viscosity has softened and can flow to wet out the steel surface of the pipe and allow the epoxy resin of one layer to flow into the epoxy resin of the adjacent layer, ensuring good interlayer adhesion. At this temperature range, the epoxy resin can flow without being overly runny, thus preventing it to sag. Also, this temperature is below the reactive temperature of the curing agents.

After this first stage of curing, the heat blanket/heat belt temperature should be raised to about 280° F. to 300° F. at an increase rate of about 5-10° F. per minute. Once this temperature range has been reached, it should be held for about 15 minutes. At this temperature, the solid curing agent powders—i.e., dicyandiamide and the accelerators will have completely melted and dispersed throughout the resin matrix. The epoxy resin mixture will begin to gel and cure will begin. The epoxy resin mixture will no longer be able to flow after this stage.

The third stage of cure is to bring the epoxy resin mixture to complete cure. The heat blanket/heat belt should be raised to about 330° F.-350° F. at an increase rate of about 5-10° F. per minute. Once this temperature range has been reached, it should be held for about 15 minutes. Complete cure will be achieved at this point.

To ramp down the temperature, the heat blanket/heat belt should be lowered to about 120° F.-140° F. at a decrease rate of about 5-10° F. per minute. Once this temperature range has been reached, it should be held for about 10 minutes. This will allow for the epoxy and fiber matrix to slowly cool down and maintain excellent adhesion to the substrate and between the fiber/resin interface. After this step, the heat blanket/heat belt can be turned off and allowed to cool to ambient temperature.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A partially-cured epoxy saturated glass, Kevlar, and/or carbon fiber fabric for use on pipeline or water pipe, comprising:
about 5-50% liquid or solid epoxy;
about 5-50% epoxy novolac resin;
about 5-10% curing agent;
about 5-10% accelerator;
about 3-15% rubber modified epoxy resin for toughening; and
about 30-70% glass and/or carbon fiber fabric.

2. The partially-cured epoxy saturated glass, Kevlar, and/or carbon fiber fabric of claim 1, wherein the partially-cured epoxy saturated glass, Kevlar, and/or carbon fiber fabric is a partially-cured epoxy saturated glass.

3. The partially-cured epoxy saturated glass, Kevlar, and/or carbon fiber fabric of claim 1, wherein the partially-cured epoxy saturated glass, Kevlar, and/or carbon fiber fabric is a partially-cured epoxy saturated Kevlar.

4. The partially-cured epoxy saturated glass, Kevlar, and/or carbon fiber fabric of claim 1, wherein the partially-cured epoxy saturated glass, Kevlar, and/or carbon fiber fabric is a partially-cured epoxy saturated carbon fiber fabric.

5. The partially-cured epoxy saturated glass, Kevlar, and/or carbon fiber fabric of claim 1, wherein the liquid or solid epoxy is selected from the group consisting of 1,2-cyclic ethers, 1,3-cyclic ethers, 1,4-cyclic ethers, and combinations thereof.

6. The partially-cured epoxy saturated glass, Kevlar, and/or carbon fiber fabric of claim 5, wherein the liquid or solid epoxy comprises more than one epoxy group.

7. A pipeline or water pipe at least partially coated with a partially-cured epoxy saturated glass, Kevlar, and/or carbon fiber fabric according to claim 1.

8. A method of making a partially-cured epoxy saturated glass and/or Kevlar and/or carbon fiber fabric for use on pipeline pipe, said method comprising:
loading fiber glass fabric and/or carbon fiber fabric onto a machine and pulling the fabric through rollers;
coating the fabric with an epoxy mix, which is in liquid form, either through use of a liquid epoxy resin or a solid epoxy that has been heated or diluted with solvent to make the solid epoxy a liquid;
saturating the fabric to create a coated fabric;
pulling the coated fabric through the rollers to squeeze the epoxy mix into the fabric and remove any excess resin and at least a portion or all of the solvent, so that there is no dripping of the epoxy resin; and
controlling the temperature to create a partially-cured epoxy saturated glass and/or Kevlar and/or carbon fiber fabric for use on pipeline pipe.

9. The method of claim 8, further comprising cutting the partially-cured epoxy saturated glass and/or carbon fiber fabric into a widths of about 2 to 12 inches.

10. A method of repairing a piece of metal pipeline pipe, comprising:
exposing a piece of pipeline pipe to be repaired;
cleaning damaged area of pipeline pipe to be repaired of debris and rust;
wiping the area around the pipe that will be repaired with a solvent cleaner;
applying epoxy filler to the damaged area;
wrapping an area of the pipe to be repaired with a fusion bonded epoxy film or coating a two-part liquid epoxy around the area of the pipe to be repaired to ensure sufficient adhesion to the steel pipe;
wrapping a glass and/or Kevlar and/or carbon fiber fabric pre-saturated with partially-cured epoxy around the repair pipe more than one time;
wrapping a peel ply comprising a nylon or polyester fabric around the pre-saturated glass and/or Kevlar and/or carbon fiber fabric;
wrapping a flexible heat belt or blanket around the peel ply; and
temperature controlling the heat belt or blanket for a cure period of time.

11. The method of claim 10, wherein the glass and/or Kevlar and/or carbon fiber fabric pre-saturated with epoxy comprises:
about 5-50% liquid or solid epoxy;
about 5-50% epoxy novolac resin:
about 5-10% curing agent;
about 5-10% accelerator;
about 3-15% rubber modified epoxy resin for toughening; and
about 30-70% glass and/or Kevlar and/or carbon fiber fabric.

12. The method of claim 11, further comprising the step of wrapping a plastic film release liner over the peel ply before wrapping the flexible heat belt or blanket.

13. The method of claim 11, wherein the cure time is about 30 minutes to about 2 hours.

14. The method of claim 11, wherein the cure temperature is about 150° F. to about 450° F.

15. A method of wrapping an epoxy composite material around a piece of metal pipeline pipe, comprising:
exposing a piece of pipeline pipe to be repaired;
cleaning damaged area of pipeline pipe to be repaired of debris and rust;
wrapping a glass fiber and/or Kevlar and/or carbon fiber fabric pre-saturated composite with a partially-cured epoxy around the pipeline pipe to be repaired more than one time;
wrapping a flexible heat belt around the composite more than one time, wherein the flexible heat belt has a width of about 4 to about 8 inches; and
temperature controlling the heat belt for a cure period of time.

16. The method of claim 15, wherein the temperature controlling step includes a three-part temperature ramping up.

17. The method of claim 16, wherein the three-part temperature ramp up comprises: increasing a temperature on the heat belt to about 200° F.-220° F. at an increase rate of about 5-10° F. per minute and holding at about 200° F.-220° F. for about 10 minutes; next, increasing the temperature on the heat belt to about 280° F. to 300° F. at an increase rate of about 5-10° F. per minute and holding at about 280° F. to 300° F. for about 15 minutes; and, next, increasing the temperature on the heat belt to about 330° F.-350° F. at an increase rate of about 5-10° F. per minute and holding at about 330° F.-350° F. for about 15 minutes.

18. The method of claim 17, wherein there is a final ramp down step comprising: lowering the temperature of the heat belt to about 120° F.-140° F. at a decrease rate of about 5-10° F. per minute and holding there for about 10 minutes before removing the heat belt from the pipeline.
